(19) United States
(12) Patent Application Publication
(10) Pub. No.: US 2009/0219796 A1
(43) Pub. Date: Sep. 3, 2009

(54) RECORD CARRIER IDENTIFICATION USING ASYMMETRY MODULATION

(75) Inventor: Josephus Arnoldus Henricus Maria Kahlman, Tilburg (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/466,630

(22) Filed: May 15, 2009

Related U.S. Application Data
(62) Division of application No. 10/598,174, filed on Aug. 21, 2006.

(30) Foreign Application Priority Data
Feb. 25, 2004 (EP) 04100739.4

(51) Int. Cl. G11B 20/00

(52) U.S. Cl. 369/47.19; G9B/20

(57) ABSTRACT

Record carrier identification information is stored using an asymmetry modulation. This prevents the access to this information through the regular data path of the playback device. The asymmetry information is automatically removed by the playback device because of the inherent data slicing and decoding that takes place in the play back device. A parameter of the asymmetry modulation is used to verify that the record carrier is authentic and not a duplicated record carrier. The parameter is disturbed by duplication processes and thus provides a reliable difficult to circumvent indication of authenticity of the record carrier.

This is a divisional or prior application Ser. No. 10/598,174 filed Aug. 21, 2006 and is incorporated by reference herein.

The invention relates to a record carrier comprising a group of channel bits recorded in a track where the group of channel bits comprises record carrier identification information, a method for recording a record identification information on a record carrier comprising a group of channel bits recorded in a track where the group of channel bits comprises record carrier identification information, a method for retrieving a record identification information from a record carrier comprising a group of channel bits recorded in a track where the group of channel bits comprises record carrier identification information, a method for copy right control of information stored on a record carrier where the record carrier comprises a record carrier comprising a group of channel bits recorded in a track of the record carrier where the group of channel bits comprises record carrier identification information, a playback device for optical discs comprising an addressing means and a data retrieval means, and a recording device for record carriers comprising an addressing means and a data recording means.

Such a record carrier is known in the form of CD and DVD record carriers where the manufacturer provides an entry on the record carrier that allows a playback device to determine who manufactured the record carrier.

Furthermore this is also known from recordable and rewriteable record carriers where a copy right notice is recorded on the record carrier.

Further more such record carriers are known from PC games where the manufacturer introduces defects on the master of the record carrier to allow playback devices to identify the record carrier by verifying whether all defects are at the expected locations.

The drawback of these record carriers is that the record carrier identification information can be readily be duplicated by anybody with access to the record carrier.

It is an objective of the invention to provide a record carrier with identification information that allow the determination whether the record carrier is an original record carrier or an unauthorized copy of a record carrier.

To achieve this objective the record carrier is characterized in that the record carrier identification information is stored in the group of channel bits with an asymmetry modulation where a parameter of the asymmetry modulation has a predetermined value.

The value of parameters of the asymmetry modulation is not available to the user through a normal playback device. The playback device comprises a data slicer and a phase locked loop in the data retrieval path which removes any asymmetry, thus preventing access to the asymmetry information, and consequently also preventing access to parameters of the asymmetry modulation. Since the value of the parameter is not available the record carrier identification cannot be duplicated on a copied record carrier with the correct asymmetry modulation having the correct parameter. It is thus possible to determine whether a record carrier is an original record carrier or a copy by simply determining whether the parameter of the asymmetry modulation is correct. If a bit for bit copy is made of the record carrier the parameter of the asymmetry modulation will deviate from the original value due to the inherent fluctuations introduced by the copy process.

One or more parameters can be controlled during the manufacturing of the original record carrier in order to increase the difficulty of copying. The playback device can, in the case of multiple parameters having a predetermined value, check multiple parameters whether they are within a predetermined range. This allows the use of both absolute predetermined values as well as ratios of two or more parameters.

An embodiment of the record carrier is characterized in that the record carrier comprises an data field for storing the predetermined value of the parameter of the asymmetry modulation.

In order to determine whether the predetermined value of the parameter of the asymmetry modulation lies within the required range, a data field of the record carrier can be used to store either the predetermined value or a range of valid predetermined values to allow a slight fluctuation of the value as determined from the record carrier. This way record carriers can be produced that have varying parameters for the asymmetry modulation. This can be useful to produce different record carriers for different batches or different types of content or different artists or for different markets, thus preventing copying of all record carriers once somebody has been able to copy a record carrier with a particular parameter with a particular value.

If the values of the parameters can vary the values of the parameters must be extracted every time a record carrier is copied which is very time consuming and makes copying unattractive.

A further embodiment of the record carrier is characterized in that the predetermined value of the parameter of the asymmetry modulation is encrypted. By encrypting the value of the parameter stored on the record carrier it is not possible to simply read the predetermined value from the record carrier and use it when duplicating i.e copying the record carrier. The encryption provides a protection to the stored value of the parameter.

A further embodiment of the record carrier is characterized in that the parameter is spread spectrum modulated.

By modulating the parameter using spread spectrum techniques, not a single constant value of the parameter can be extracted. A key for despreading the spread spectrum modulation is required to extract the value of the parameter. If the key is not available the value of the parameter is hidden in the noise introduced by the spread spectrum modulation.

A further embodiment of the record carrier is characterized in that the value of the parameter is different in a first section of the record carrier compared to a second section of the record carrier.

By varying the value of the parameter from section to section of the record carrier it is not possible to determine the value for a section of the original record carrier and apply it to the entire duplicated record carrier. This makes duplication much more difficult because the pattern of the distribution of the variations in the value of the parameter have to be duplicated on the copied record carrier as well.

The pattern of the variation can either be fixed or variable, in which case information about the pattern can be stored in encrypted form on the record carrier.

A further embodiment of the record carrier is characterized in that the record carrier is a read only record carrier. The invention functions with both recordable and read-only record carriers. Read-only record carriers are however the most prevalent target of copying attempts because a read-only record carrier comprises predominantly copy righted materials that require protection against unauthorized duplication by copying.

The application of the present invention to a read-only record carrier clearly benefits the read-only carrier in particular.

A further embodiment of the record carrier is characterized in that the record carrier identification information is stored in a predetermined position

Storing the record carrier identification information in a predetermined position allows the playback device to quickly retrieve the asymmetry of the channel bits in that location and determine the stored record carrier identification information without having to search parts or the entire record carrier for a group of channel bits with an asymmetry modulation.

The asymmetry modulation can be a pit width modulation.

A wider pit exhibits a lower reflection, effectively locally disturbing the DC level, thus introducing an asymmetry of a group of channel bits. One or more of these disturbances of the DC level of the channel bits can be used to represent, via a modulation, the record carrier identification information. The parameter is in this case for instance the pit width and the value of the pit width can be chosen to be stored on the record carrier. An analog copy will disturb the pit width and the value determined from the copied record carrier will thus differ from the value stored on the copied record carrier since this was copied from the original record carrier.

Information about the amount of reflection is removed by the data slicer before the data is being processed by the playback device. Access to information about the DC content, and thus to the amount of reflection and thus the pit width is not possible without special arrangements in the playback device.

The asymmetry modulation can be a running digital sum modulation.

The channel code normally strives to provide a running digital sum of the code words as close to zero as possible. Control over the running digital sum can for instance be achieved by using replacement code words where at given instances in the stream of code words a code word can be replaced by another unique code word that results in a lower running digital sum if this is advantageous for the running digital sum. If the replacement code word results in a higher running digital sum the code word is not replaced by the replacement code word. To store record carrier identification information on the record carrier this scheme can be altered by replacing the code word by the replacement code word if that is would result in a higher running digital sum. This deviation from the expected scheme is thus used to modulate the record carrier information and is effectively an asymmetry modulation because the code words locally exhibit a higher DC content than expected. The amount of deviation, also called the amplitude of the deviation is in this case the parameter used to identify the original record carrier by comparing the measured value determined from the record carrier to the value stored on the record carrier. The asymmetry modulation can be a channel bit transition position modulation.

By repositioning the transitions of the channel bits the DC content can be modulated and asymmetry achieved. Because the subsequent PLL realigns the transitions with the extracted clock the data stream is not affected while a low frequency content near DC can be introduced in the spectrum of the HF stream of channel bits which is subsequently detectable for identification purposes. The frequency of one or more of the peaks in the low frequency range thus introduced in the spectrum or the amplitude of one or more of the peaks can be used as a parameter. The corresponding value would then be the frequency of the peaks or the amplitude of the peaks, or both.

The record carrier identification information can be stored in a predetermined position.

Storing the record carrier identification information in a predetermined position allows the playback device to quickly retrieve the asymmetry of the channel bits in that location and determine the stored record carrier identification information without having to search parts or the entire record carrier for a group of channel bits with an asymmetry modulation.

A pointer to the predetermined position can be stored on the record carrier.

In order to prevent the information to be stored in the same position on each and every record carrier a pointer is stored on each record carrier, either encrypted, i.e. in a well protected form, or unprotected.

When the record carrier comprises a pointer the playback device can find the record carrier identification information of every record carrier quickly.

The location of the predetermined position can be stored in the startup information area such as the PIC band.

The PIC band is defined by the blu-disc standard and is suitable to store the pointer in encrypted or unprotected form.

A method for recording a record identification information on a record carrier comprising a group of channel bits recorded in a track where the group of channel bits comprises record carrier identification information, comprising the step of:
modulating the record carrier identification information in the group of channel bits with an asymmetry modulation;
storing the group of channel bits with an asymmetry modulation on the record carrier where a parameter of the asymmetry modulation has a predetermined value.

By executing this method a record carrier is created that allows the retrieval of the record carrier identification information from the record carrier by a player while preventing exact duplication of the record carrier by placing the identification information on the record carrier in such a way that a direct extraction through the normal data path of the playback device is not possible. Storing the record carrier identification such that a parameter of the asymmetry modulation has a predetermined value it is later on possible to detect whether the parameter still has that value, or lies within an acceptable range around that value, indicating that the record carrier identification information is read from an original record carrier, not from a copied record carrier.

The step of modulating the record carrier identification information in the group of channel bits with an asymmetry modulation can comprise the step of modulating a running digital sum of the channel bits.

By inserting the modulation in the running digital sum the record carrier identification information is only accessible to the playback device internally and not through the normal data path of the playback device, preventing the extraction of the identification information by a regular user.

Control over the running digital sum can for instance be achieved by using replacement code words where at given instances in the stream of code words a code word can be replaced by another unique code word that results in a lower running digital sum if this is advantageous for the running digital sum. If the replacement code word results in a higher running digital sum the code word is not replaced by the replacement code word. To store record carrier identification information on the record carrier this scheme can be altered by replacing the code word by the replacement code word if that is would result in a higher running digital sum. This deviation from the expected scheme is thus used to modulate the record carrier information and is effectively an asymmetry modulation because the code words locally exhibit a higher DC content, or other deviation caused by asymmetry modulation, than expected.

Alternatively the watermark is applied according to a spread-spectrum technique.

The key required for the detection is encoded into the disc, preferably in encrypted form.

Another alternative is the introduction of a watermark in the form of an analogue signal e.g. a sine wave, or a modulated sine wave (AM, FM, PM etc.).

When using the channel bit transition modulation the detection is carried out by observing the transition positions with respect to the detection moments achieved by using a PLL and data slicer with a faster threshold determination. In this embodiment the watermark bandwidth can be higher.

A further embodiment of the method for recording a record carrier identification information is characterized in that the method comprises the step of storing the predetermined value of the parameter of the asymmetry modulation in a data field on the record carrier.

By storing the predetermined value of the parameter on the record carrier the playback device can retrieve this information when needed and use it to determine whether the measured value of the parameter is equal to, or within a predetermined range, of the retrieved information about the predetermined value. Thus the predetermined value can be varied from record carrier to record carrier and need no longer be constant. The player can adjust the requirements for authentication using the parameter to the predetermined value as retrieved from the record carrier.

Storing predetermined value of the parameter of the asymmetry modulation in a predetermined position allows the playback device later on to quickly retrieve the predetermined value of the parameter of the asymmetry modulation because the location where the value can be retrieved from is known. This allows for a quick determination whether the stored record carrier identification information is authentic.

An embodiment of the method for recording a record carrier identification information is characterized in that the predetermined value of the parameter of the asymmetry modulation is encrypted.

By encrypting the value of the parameter stored on the record carrier it is not possible to simply read the predetermined value from the record carrier and use it when duplicating i.e copying the record carrier. The encryption provides a protection to the stored value of the parameter.

An further embodiment of the method for recording a record carrier identification information is characterized in that the step of modulating the record carrier identification information in the group of channel bits with an asymmetry modulation comprises the step of modulating the value of the parameter using a spread spectrum modulation

By modulating the parameter using spread spectrum techniques, not a single constant value of the parameter can be extracted. A key for despreading the spread spectrum modulation is required to extract the value of the parameter. If the key is not available the value of the parameter is hidden in the noise introduced by the spread spectrum modulation.

An further embodiment of the method for recording a record carrier identification information is characterized in that the step of modulating the record carrier identification information in the group of channel bits with an asymmetry modulation comprises the step of modulating the record carrier identification information in the group of channel bits that are to be stored in a first section of the record carrier with an asymmetry modulation with a parameter having a first value and the step of modulating the record carrier identification information in the group of channel bits that are to be stored in a second section of the record carrier with an asymmetry modulation with a parameter having a second value.

By varying the value of the parameter from section to section of the record carrier it is not possible to determine the value for a section of the original record carrier and apply it to the entire duplicated record carrier. This makes duplication much more difficult. The pattern of the variation can either be fixed or variable, in which case information about the pattern can be stored in encrypted form on the record carrier.

An further embodiment of the method for recording a record carrier identification information is characterized in that the step of modulating the record carrier identification information in the group of channel bits with an asymmetry modulation comprises the step of modulating the record carrier identification information in the group of channel bits that are to be stored in a first section of the record carrier with an asymmetry modulation with a parameter having a first value and the step of modulating the record carrier identification information in the group of channel bits that are to be stored in a second section of the record carrier with an asymmetry modulation with a parameter having a second value.

By varying the value of the parameter from section to section of the record carrier it is not possible to determine the value for a single section of the original record carrier and apply it to the entire duplicated record carrier. This makes duplication much more difficult because the pattern of the distribution of the variations in the value of the parameter have to be duplicated on the copied record carrier as well.

The pattern of the variation can either be fixed or variable, in which case information about the pattern can be stored in encrypted form on the record carrier.

A further embodiment of the method for recording a record carrier identification information is characterized in that the record carrier comprises a Startup information area and that a location of the data field is stored in the Startup information area.

The Startup information area is defined by the blu-disc standard and is suitable to store the location of the data field where the predetermined value of the parameter is stored in encrypted or unprotected form.

A method according to the invention for retrieving a record identification information from a record carrier comprising a group of channel bits recorded in a track where the group of channel bits comprises record carrier identification information, comprising the step of:

retrieving a group of channel bits with an asymmetry modulation from the record carrier;

demodulating the record carrier identification information from the retrieved group of channel bits with an asymmetry modulation;

retrieving a value of a parameter of the asymmetry modulation

comparing the retrieved value of the parameter to a predetermined value

providing the record carrier identification information if the retrieved parameter is within a predefined range of the predetermined value.

By executing this method a record carrier is created that allows the retrieval of the record carrier identification information from the record carrier by a player while preventing exact duplication of the record carrier by placing the identification information on the record carrier in such a way that a direct extraction through the normal data path of the playback device is not possible. Storing the record carrier identification such that a parameter of the asymmetry modulation has a predetermined value it is later on possible to detect whether the parameter still has that value, or lies within an acceptable range around that value, indicating that the record carrier identification information is read from an original record carrier, not from a copied record carrier. A value that is within the predetermined range indicates that the record carrier identification information is valid while a value that lies outside the predetermined range indicates an illegal copy with invalid record identification information.

The asymmetry modulation prevents the user to access the record carrier identification information through the normal data path since there are no provisions in a playback device for this.

Because of the data slicer used in the playback device the asymmetry modulation is removed before the data is extracted from the code words.

If alternatively the asymmetry modulation is achieved during coding into code words the removal of the asymmetry modulation is performed during the retrieval of the data from the code words.

Yet easy retrieval and verification of the record carrier identification information can be achieved in the playback device by providing demodulation means that are located before the data slicer or before the decoding of the code words so that the asymmetry demodulation means is provided with the signal retrieved from the record carrier where the signal still contains the asymmetry modulation.

The retrieval of the asymmetry modulation can for example be achieved after the data slicer when the asymmetry modulation has been achieved by coding. After the data slicer the replacement code words as used for the control of the DC content are still present and at during the decoding of these code words the information stored using the asymmetry modulation becomes available. Whenever a code word is encountered that is either a replacement code word or a code word that could potentially be replaced by a replacement code word the actual decision to replace or to not replace can be compared to the, for DC control, expected optimum decision. Deviations from the optimum decision form the basis of the asymmetry modulation and demodulation can thus be achieved.

An embodiment of the method for retrieving a record carrier identification information is

characterized in that the step of comparing the value of the parameter to a predetermined value comprises the step of retrieving the predetermined value from a data field on the record carrier.

By retrieving the predetermined value of the parameter from the record carrier the playback device can use the predetermined value to determine whether the measured value of the parameter is equal to, or within a predetermined range, of the retrieved predetermined value. Thus the predetermined value can be varied from record carrier to record carrier and need no longer be constant. The player can adjust the requirements for authentication of the record carrier to the predetermined value as retrieved from the record carrier.

Retrieving the predetermined value of the parameter of the asymmetry modulation from a predetermined position allows the playback device to quickly retrieve the predetermined value of the parameter of the asymmetry modulation because the location where the value can be retrieved from is known. This allows for a quick determination whether the stored record carrier identification information is authentic.

A further embodiment of the method for retrieving a record carrier identification information is characterized in that the step of comparing the value of the parameter to a predetermined value comprises the step of retrieving the predetermined value from a location via a network.

The predetermined value can also be retrieved over a network, instead of being retrieved from the record carrier itself. This allows the owner of the copyrighted material to control who has access to the predetermined value. The owner of the record carrier no longer has direct access to the predetermined value and must access a data base to retrieve the predetermined value for that record carrier. This allows the owner of the copyrighted material to log who has accessed the information. Especially in combination with encryption this allows a strict control of access to the predetermined value. To crack an encryption of the predetermined value a large number of accesses to the encrypted predetermined value are required which goes undetected when the encrypted predetermined value is recorded on the record carrier but is easily detectable when performed over a network since every access exceeds the physical boundaries of the playback device and can be observed on the network in the form of network traffic.

A further embodiment of the method for retrieving a record carrier identification information is characterized in that the step of retrieving a value of a parameter of the asymmetry modulation is preceded by the step of demodulating the value of the parameter using a spread spectrum demodulation

By modulating the parameter using spread spectrum techniques, not a single constant value of the parameter can be extracted. A key for despreading the spread spectrum modulation is required to extract the value of the parameter. If the key is not available the value of the parameter is hidden in the noise introduced by the spread spectrum modulation. Using the appropriate key the value of the parameter can easily be extracted from the record carrier by the authorized user. It thus constitutes a hurdle for unauthorized duplication of the record carrier while allowing the playback device to easily distinguish an authorized record carrier from an unauthorized duplicated record carrier.

A further embodiment of the method for retrieving a record carrier identification information is characterized in that the step of demodulating the record carrier identification information in the group of channel bits with an asymmetry modulation comprises the step of retrieving a parameter having a first value from a first group of channel bits with an asymmetry modulation that are stored in a first section of the record carrier and retrieving a parameter having a second value from a second group of channel bits with the asymmetry modulation that are stored in a second section of the record carrier

By varying the value of the parameter from section to section of the record carrier it is not possible to determine the value for a section of the original record carrier and apply it to the entire duplicated record carrier. This makes duplication much more difficult because the pattern of the distribution of the variations in the value of the parameter have to be duplicated on the copied record carrier as well. On an original record carrier the playback device can, knowing the locations where to retrieve the value of the parameter from, quickly verify the authenticity of the record carrier.

The pattern of the variation can either be fixed or variable, in which case information about the pattern can be retrieved in encrypted form from the record carrier.

A further embodiment of the method for retrieving a record carrier identification information is characterized in that the record carrier comprises a Startup information area and that the pointer of the predetermined position is retrieved from the Startup information area.

The Startup information area is defined by the blu-disc standard and is suitable to store the location of the data field where the predetermined value of the parameter is stored in encrypted or unprotected form.

A method for copy right control of information stored on a record carrier where the record carrier comprises a record carrier comprising a group of channel bits recorded in a track of the record carrier where the group of channel bits comprises record carrier identification information, comprising the step of:
retrieving a group of channel bits with an asymmetry modulation from the record carrier;
retrieving a value of a parameter of the asymmetry modulation from the retrieved group of channel bits;
comparing the value of the parameter with a predetermined value;
if the value of the parameter is within a predetermined range of the predetermined parameter: complete processing the retrieved group of channel bits to establish a copy right status of the record carrier;
if the value of the parameter is outside a predetermined range of the predetermined parameter: declare a copy right status of the record carrier to be a violation of a copy right.

The asymmetry modulation prevents the user to access the record carrier identification information through the normal data path since there are no provisions in a playback device for accessing asymmetry modulated data. There are also no provisions in the playback device for access a parameter or retrieve a value of such a parameter of the asymmetry modulation.

Because of the data slicer and phase locked loop used in the playback device the asymmetry modulation is removed before the data is extracted from the code words.

If alternatively the asymmetry modulation is achieved during coding into code words the removal of the asymmetry modulation is performed during the retrieval of the data from the code words. The code words cannot be accessed by the user through the normal data path.

Yet easy retrieval and verification of the record carrier identification information can be achieved in the playback device by providing demodulation means and parameter retrieval means that are located before the data slicer and/or phase locked loop or before the decoding of the code words where the parameter is still present in the signal retrieved from the record carrier.

After retrieving the value of the parameter the playback device can determine the copy right status of the material on the record carrier.

If the value of the parameter is within a range of the predetermined value this is an indication that the record carrier is an original authentic record carrier and that the content of the record carrier complies with the requirements of the copy right laws. Depending on the copyright law the playback device may then decide to allow duplication or to prevent duplication.

For instance if a backup copy of the record carrier is allowed the copy will be made to a record carrier but the value of the parameter cannot be duplicated on that copy of the record carrier. Further duplication is thus stopped because when a playback device is asked to release the content on the copy of the record carrier for further duplication the playback device will notice that the record carrier is already a copy and further duplication is not allowed by the copyright laws.

If the copy right indicates that the content, or portions thereof, on the record carrier may not be duplicated the playback device can refuse requests for the material from a recording device or indicate to the recording device that duplication is illegal. The mechanisms to prevent illegal duplication can be located in either the playback device or the recorder.

Alternatively the record carrier identification information can be used to prevent any playback of illegal record carriers. Those illegal record carriers will not have the proper value of the parameter because the value is changed during the duplication as outlined above. The playback device will refuse the access to the content on the record carrier whenever the proper record carrier identification information is missing or incorrect.

An embodiment of the method for copy right control of information stored on a record carrier is characterized in that the step of comparing the value of the parameter with a predetermined value comprises the step of retrieving the predetermined value of the parameter of the asymmetry modulation from a data field on the record carrier

By retrieving the predetermined value of the parameter from the record carrier the playback device can use the predetermined value to determine whether the measured value of the parameter is equal to, or within a predetermined range, of the retrieved predetermined value. Thus the predetermined value can be varied from record carrier to record carrier, or from master to master in the case of read only record carriers, and need no longer be constant. The player can adjust the requirements for authentication of the record carrier to the predetermined value as retrieved from the record carrier.

Retrieving the predetermined value of the parameter of the asymmetry modulation from a predetermined position allows the playback device to quickly retrieve the predetermined value of the parameter of the asymmetry modulation because the location where the value can be retrieved from is known. This allows for a quick determination whether the stored record carrier identification information is authentic.

A further embodiment of the method for copy right control of information stored on a record carrier is characterized in that the step of comparing the value of the parameter to a predetermined value comprises the step of retrieving the predetermined value from a location via a network.

The predetermined value can also be retrieved over a network, instead of being retrieved from the record carrier itself. This allows the owner of the copyrighted material to control who has access to the predetermined value. The owner of the record carrier no longer has direct access to the predetermined value and must access a data base to retrieve the predetermined value for that record carrier. This allows the owner of the copyrighted material to log who has accessed the information. Especially in combination with encryption this allows a strict control of access to the predetermined value. To crack an encryption of the predetermined value a large number of accesses to the encrypted predetermined value are required which goes undetected when the encrypted predetermined value is recorded on the record carrier but is easily detectable when performed over a network since every access exceeds the physical boundaries of the playback device and can be observed on the network in the form of network traffic.

An embodiment of the method for copy right control of information stored on a record carrier is characterized in that the record carrier comprises a Startup information area and that a location of the data field is retrieved from the Startup information area. The Startup information area is defined by the blu-disc standard and is suitable to store the location of the data field where the predetermined value of the parameter is stored in encrypted or unprotected form.

A playback device for optical discs comprising an addressing means and a data retrieval means according to the invention is characterized in that the playback device further comprises a asymmetry retrieval means that is arranged for retrieving a record carrier identification information from a record carrier comprising a demodulator for demodulating an asymmetry of a group of channel bits retrieved from the record carrier from an address indicated by the addressing means and that a parameter retrieval means is coupled to the asymmetry retrieval means for retrieving a value of a parameter of the asymmetry of the group of channel bits.

An embodiment of the playback device according to the invention is characterized in that the playback device further comprises a copy right control means of which an input is coupled to an output of the parameter retrieval means for receiving a value of the parameter and where the copy right control means is arranged for determining a copy right status based on the value of the parameter received from the parameter retrieval means.

A recording device for record carriers according to the invention comprising an addressing means and a data recording means is characterized in that the recording device further comprises a asymmetry modulation device that is arranged for storing a record carrier identification information on a record carrier by modulating an asymmetry of a group of channel bits, where the asymmetry has a predetermined value, where the asymmetry modulation device is coupled to the data recording means which is arranged for recording the group of channel bits provided by the asymmetry modulation device on an location on the record carrier indicated by the addressing means.

The invention will now be discussed based on figures.

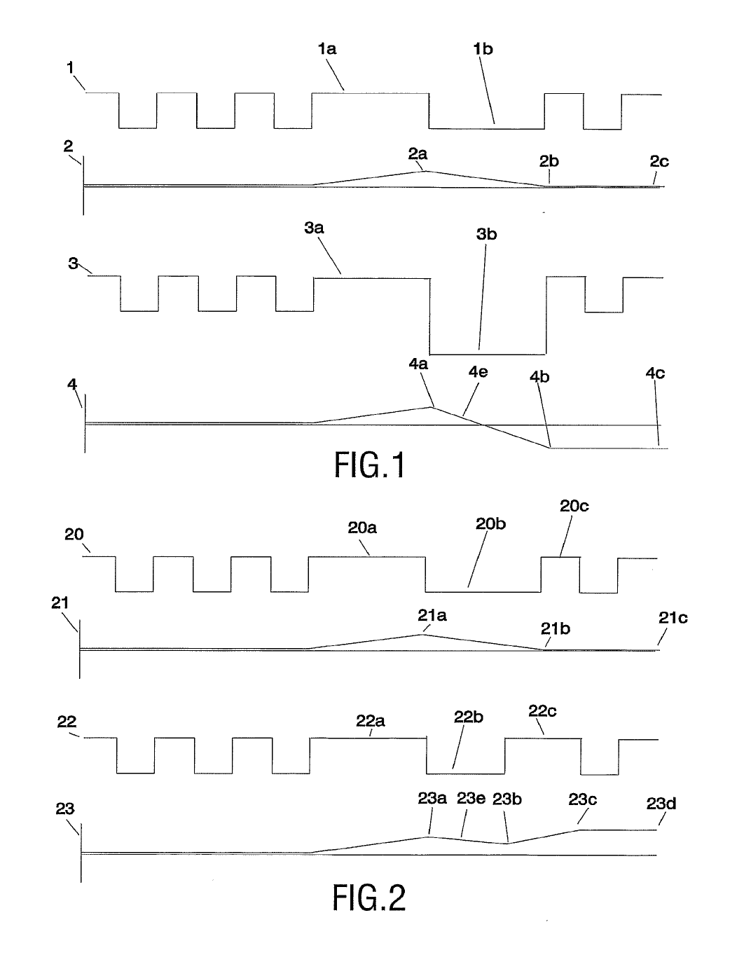

FIG. 1 shows asymmetry of channel bits through pit width modulation

FIG. 2 shows asymmetry of channel bits through coding

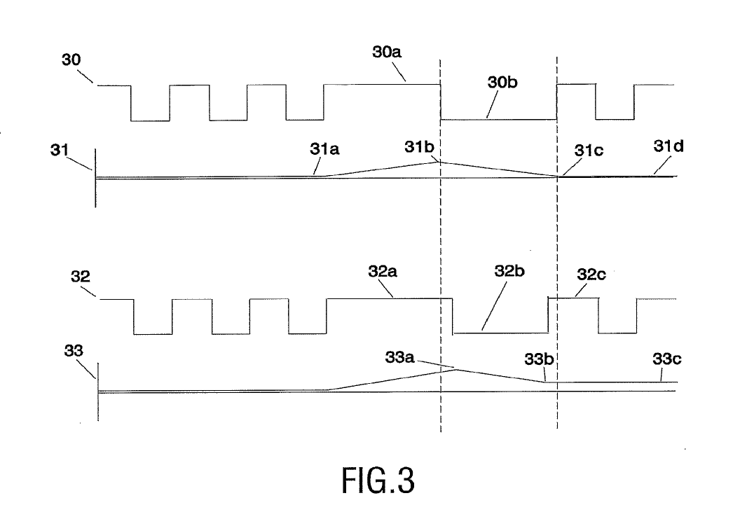

FIG. 3 shows asymmetry of channel bits through transition modulation.

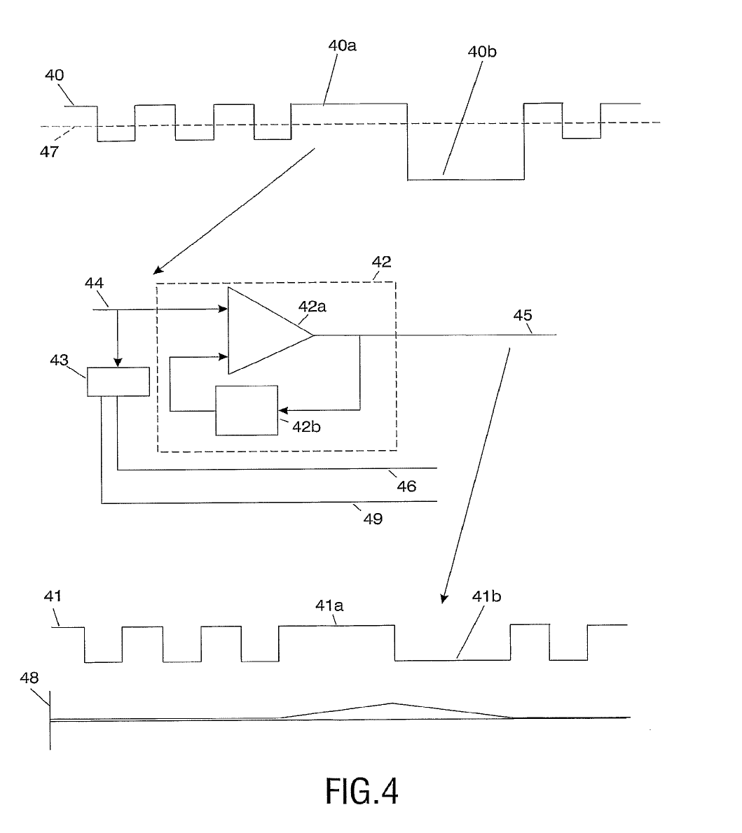

FIG. 4 shows the effect of a data slicer on the asymmetry

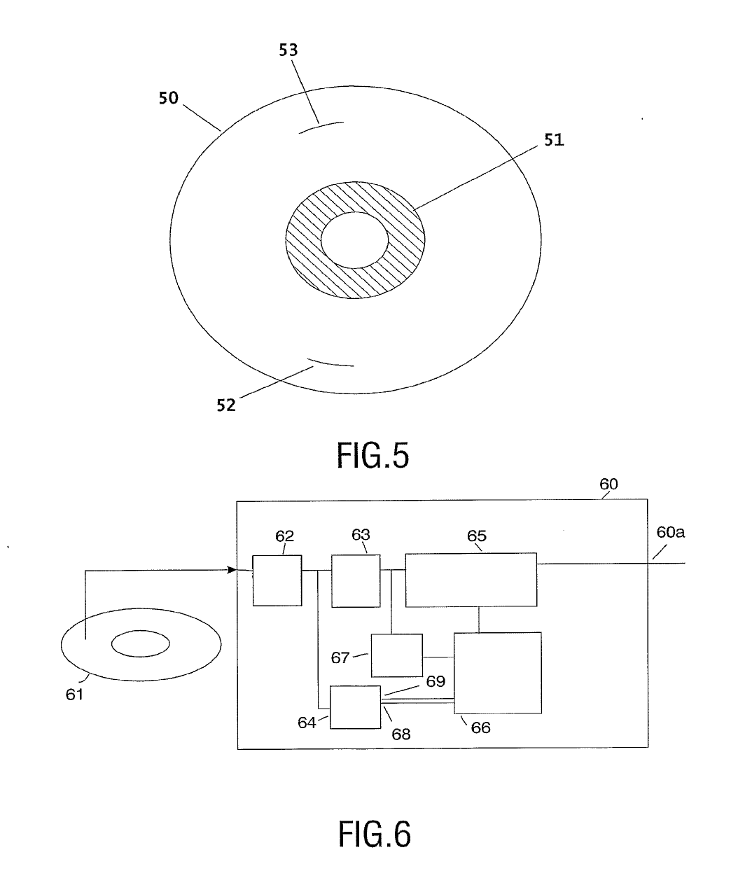

FIG. 5 shows a record carrier with asymmetry

FIG. 6 shows a playback device comprising the asymmetry detector

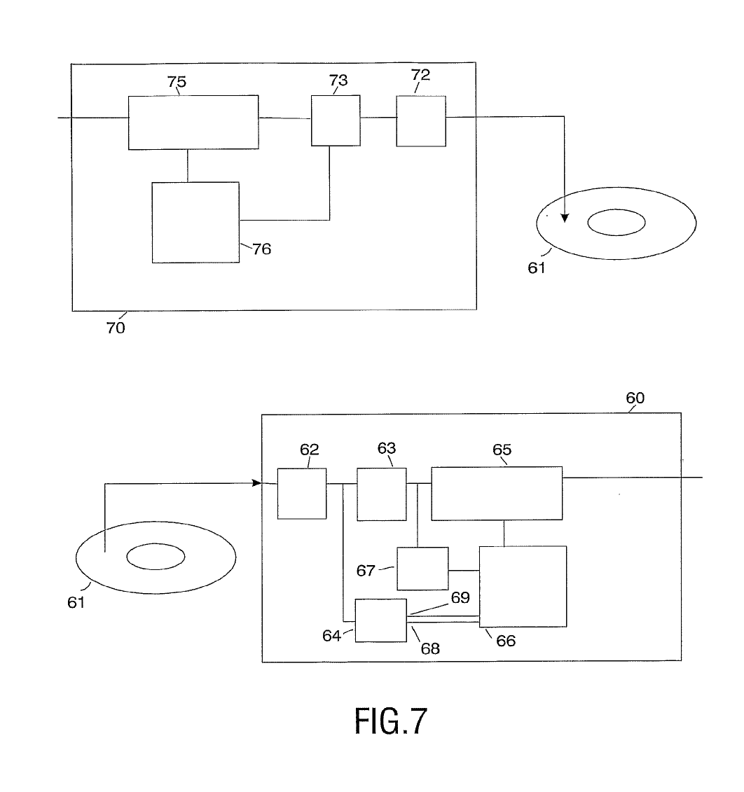

FIG. 7 shows a copy right control system using asymmetry as a watermark.

It should be noted that although the explanation uses a local asymmetry disturbance, a more statistical approach where the disturbance is spread over more groups of channel bits, such as achieved by spread spectrum techniques can be equally applied.

FIG. 1 shows asymmetry of channel bits through pit width modulation A group of normal non-modulated channel bits 1 is shown. A high level indicates a reflection of the light by the record carrier, i.e. a land, while a low level indicates a low reflection, i.e. a mark.

Furthermore DC content curves 2,4 are shown. The DC content of the signal is determined by integrating the contribution of the various bits.

The group of normal non-modulated channel bits 1 comprises, for illustration purposes, a series of short alternations of lands and marks. The average contribution to the DC content of the group of channel bits is zero, indicated by a constant value in the corresponding sections of the DC content curve 2. When a longer land 1a leads to a longer duration of the reflection the DC content curve 2 increases to a first level 2a by providing a positive contribution. Subsequently a equally long mark 1b with low reflectivity balances the DC content curve 2 back to zero by providing a negative contribution, thus decreasing the DC content.

When the width of the pit is increased the reflection of the mark is further decreased compared to the normal situation discussed above.

A modulated group of channel bits 3 comprises such a wider pit, represented by a lower reflection of the longer mark 3b. The longer mark 3b provides a more negative contribution than the longer land 3a. Consequently, when the DC content curve reaches a first level 4a, equal to the first level 2a of the normal situation, the negative contribution of the longer mark 3a causes the DC content to reach a negative value 4b, instead of just returning the DC content curve 4 to zero.

It is a desirable property of signals to be DC content free. The DC content is for that reason kept low and a return to zero of the DC content at the end of groups of channel bits, code words, or groups of code words.

A deviation from zero at the end 4c of a group of channel bits can thus be detected as an abnormal situation, enabling the modulation of the DC content as outlined to represent data or a marker or a watermark.

In addition to detecting the presence of a disturbance, the amount of disturbance is also determined. In the case of FIG. 1 the parameter that is measured is the amount of the disturbance. The amount is an analog value when measured because the pit width is an analog value and directly relates to the amount of disturbance. The amount of disturbance is indicated by the section 4e of the curve between the point corresponding to the start of the disturbance 4a and the end of the disturbance 4b. The length, the slope and the absolute level of sections such as the section 4e are analog values and could be used as a measure of the amount of disturbance. Since the pit width deviates from the normal pit width the illegal duplication process has to duplicate the exact pit width to achieve the exact same amplitude of the disturbance. Copying the exact pit width is difficult because during the retrieval of the data information about the pit width is lost after slicing and reclocking by the phase locked loop. Even a physical copy made directly from the disc will result in changes in the pit width thus ensuring that the value of the parameter of the asymmetry modulation is changed and the copy thus being distinguishable from the original.

FIG. 2 shows asymmetry of channel bits through coding

A group of normal non-modulated channel bits 20 is shown. A high level again indicates a reflection of the light by the record carrier, i.e. a land, and a low level again indicates a low reflection, i.e. a mark.

The group of normal non-modulated channel bits 20 comprises, for illustration purposes, a series of short alternations of lands and marks. The average contribution to the DC content of the group of channel bits is zero, indicated by a constant value in the corresponding sections of the DC content curve 21. When a longer land 20a leads to a longer duration of the reflection the DC content curve 21 increases to a first level 21a by providing a positive contribution. Subsequently a equally long mark 20b with low reflectivity balances the DC content curve 21 back to zero 21b by providing a negative contribution, thus decreasing the DC content.

When the coding is used to introduce asymmetry in the group of channel bits a different pattern of bits is produced compared to the normal situation discussed above.

A modulated group of channel bits 22 comprises such a different pattern of bits, represented by a shorter duration mark 22b, when compared to the corresponding longer mark 20b, and a longer duration land 22c, when compared to the corresponding shorter land 20c. The shorter mark 22b provides a shorter negative contribution than the longer land 20b. Consequently, when the DC content curve 23 reaches a first level 23a, equal to the first level 21a of the normal situation, the negative contribution of the longer mark 22b causes the DC content to decrease to a positive value 23b, instead of just returning the DC content curve 23 to zero.

The longer land 22c subsequently provides a positive contribution to the DC content, resulting in an even more positive end value 23d of the DC content curve 23. It is a desirable property of signals to be DC content free. The DC content is for that reason kept low and a return to zero of the DC content at the end of groups of channel bits, code words, or groups of code words.

A deviation from zero at the end 23d of a group of channel bits can thus be detected as an abnormal situation, enabling the modulation of the DC content as outlined to represent data or a marker or a watermark.

In addition to detecting the presence of a disturbance, the amount of disturbance is also determined. In the case of FIG. 2 the parameter that is measured is the amount of the disturbance. The amount is an analog value when measured because the coding can be altered to achieve various amounts of disturbance. The amount of disturbance is indicated by the section 23e of the curve between the point corresponding to the start of the disturbance 23a and the end of the disturbance 23b. The length, the slope and the absolute level of sections such as section 23e are analog values and could be used as a measure of the amount of disturbance. Since the pit length deviates from the normal expected pit width the illegal duplication process has to duplicate the exact pit length to achieve the exact same amplitude of the disturbance. Copying the exact pit length is difficult because during the retrieval of the data information about the pit length is lost due to reclocking by the phase locked loop. Even a physical copy made directly from the disc will result in changes in the pit length thus ensuring that the value of the parameter, for instance the slop, length or absolute amplitude of a section of the DC content curve 23 of the of the asymmetry modulation is changed and the copy thus being distinguishable from the original.

FIG. 3 shows asymmetry of channel bits through transition modulation, i.e. flank position modulation.

The situation when modulating the transitions of the channel bits is similar to the situation discussed in FIG. 2. A modification of the duration of lands and marks disturbs the symmetry, resulting in a non zero DC content at the end of the channel bits. In FIG. 3 this is however not achieved by applying a different coding as in FIG. 2, but is the result of shifting the transitions themselves. For flank shifting an analog parameter is the amount of shift from the ideal expected position. It is equivalent to the purposely introduction of jitter to the signal. In order to be able to retrieve the data the shifting of the transitions is limited because subsequent detection after clock recovery must result in the same data being retrieved compared to the situation where no shifting of the transitions took place.

A group of normal non-modulated channel bits 30 is shown. A high level again indicates a reflection of the light by the record carrier, i.e. a land, and a low level again indicates a low reflection, i.e. a mark.

The group of normal non-modulated channel bits 30 comprises, for illustration purposes, a series of short alternations of lands and marks. The average contribution to the DC content of the group of channel bits is zero, indicated by a constant value in the corresponding sections of the DC content curve 31. When a longer land 30a leads to a longer duration of the reflection the DC content curve 31 increases to a first level 31b by providing a positive contribution. Subsequently a equally long mark 30b with low reflectivity balances the DC content curve 3 back to zero 31c by providing a negative contribution, thus decreasing the DC content.

When the shifting of the transitions is used to introduce asymmetry in the group of channel bits the width of lands and marks are changed. Moving a single transition between a land and a mark does not change the overall length but does change the mark to land ratio.

A modulated group of channel bits 32 comprises such a shifted transition. The extended land 32a provides a positive contribution for a longer time to the DC content resulting in a higher level 33a when compared to the level 31b reached in the normal situation. The subsequent reduced mark 32b provides a negative contribution for a shorter time with the consequence that the DC content 33 no longer returns to zero at the end 33c of the group of channel bits.

It is a desirable property of signals to be DC content free. The DC content is for that reason kept low and a return to zero of the DC content at the end of groups of channel bits, code words, or groups of code words.

A deviation from zero at the end 23d of a group of channel bits can thus be detected as an abnormal situation, enabling the modulation of the DC content as outlined to represent data or a marker or a watermark.

At a specific location on the disc, the a-symmetry of a group of channel-bits is modulated. This measure generates a non-copy-able watermark on the disc. At playback this asymmetry can be recovered from the DC content. If the content and the location of the watermark are not correct, the player refuses to play the disc.

Because virtual all disc copy methods restore the timing of the channel bits, the watermark will disappear after disc cloning. Only full analogue copying without timing restoration will retain the watermark, but this will lead to an increase of timing jitter on the copy. This may make the copy unplayable or at least identifiable as a copy by noting the increased levels of jitter.

In addition to merely detecting the presence of the disturbance caused by the shifting of the transitions, the amount of disturbance is also determined. In the case of FIG. 3 the parameter that is measured is the amount of the shift. This can be accomplished by measuring the time difference between the actual transition position and the expected ideal transition position as for instance determined by performing clock recovery. Alternatively it is possible to perform a statistical analysis. The amount is an analog value when measured because the deviation of the flank transition is an analog value and directly relates to the amount of disturbance. The amount of disturbance is indicated by the section 32d and 32e. The length, of these sections 32d, 32e indicate the duration of the deviation of the transition position from the expected transition position. The duration of the deviation are analog values and can be used as a measure of the amount of disturbance. Since the pit length is changed during a duplication of the disc the transition positions will consequently deviate from the expected transition positions as found on the original. The illegal duplication process has to duplicate the transition positions to achieve the exact same deviations to duplicate the parameter on the copy of the disc. Copying the exact transition location is difficult because during the retrieval of the data information about the transition position is lost due to reclocking by the phase locked loop. Even a physical copy made directly from the disc will result in changes in the transition positions, caused by slight changes in the pit length introduced by the duplication process, thus ensuring that the value of the parameter of the asymmetry modulation is changed and the copy thus being distinguishable from the original.

FIG. 4 shows the effect of a data slicer on the asymmetry

The effect of the slicer is discussed using a group of channel bits that include a lower reflection because of a wider pit as an example.

The group of channel bits 40 comprise a longer land 40a and a longer mark 40b.

The length of the other lands and marks is kept shorter for illustration purposes and does not necessarily reflect an actual existing or possible group of channel bits. They are merely given a different size to set them apart from the land and mark for the discussion of the invention.

This group of channel bits is fed to a conventional data slicer 42 via the input 44, comprising a comparator 42a and a device 42b to establish the proper detection threshold 47.

The device 42b provides the proper threshold 47 to the comparator 42a allowing the comparator 42a to provide an output signal 41 comprising all the timing information of the group of channel bits 40 while removing any amplitude variations such as the lower level of the mark 40b. The duration of the longer land 41a and the longer mark 41b is equal to the long land 40a and long mark 40b of the channel bits. The data slicer provides the output signal 41, representing the channel bits at the output 45 but with the level of the longer mark 41b equal to the level of other marks.

Consequently the information as stored by the modulation in the channel bits 40 is lost in the output signal 41.

In addition to providing the channel bits 40 to the data slicer 42 the channel bits 40 are also provided to the DC content device 43, implemented for instance in the form of an integrator. The DC content device 43 then provides the determined DC content at the output 46. The DC content device 43 also provides the measured value of the parameter at the output 49. The DC content so provided deviates from the expected DC content. This can easily be determined because the output signal 41 from the data slicer is DC free as illustrated by the DC content curve 48.

A simple comparison between the DC content before and after the data slicer will reveal differences, allowing the detection and demodulation of the record carrier identification information.

By providing the value of the parameter to other parts of the playback device such as a processor a program executed by the processor can determine whether the disc is an original disc by comparing the value of the parameter provided by the DC content device 43 to the expected predetermined value. This allows the playback device to establish the copy right status.

It is to be noted that FIG. 4 illustrates the case where a reflection change is used to disturb the DC content. In the case of timing variations such as the shifting of transitions or the use of coding the data slicer does not remove the record carrier identification information but the decoding step, where the replacement code words are replaced by the original code words, or the clock recovery and subsequent sampling will remove the disturbances of the DC content. In that case respectively the decoder or a circuit processing both output of the slicer and information from the clock recovery provides the value of the parameter to the processor.

In the case of the shifting of the transitions the Phase Locked Loop (PLL) used for clock recovery from the channel bits can provide the demodulation since the shifting of the transitions will show up as an error signal at the phase comparator of the PLL. The amplitude of the error signal is a measure for the amount the transition is shifted from the ideal transition position as expected by the phase locked loop and can thus be used as the value and parameter that is to be provided to the processor.

At a specific location on the disc, the a-symmetry of a group of channel-bits is modulated. This measure generates a non-copy-able watermark on the disc. At playback this asymmetry can be recovered. If the content and the location of the watermark are not correct, the player refuses to play the disc.

Because virtual all disc copy methods restore the timing of the channel bits, the watermark will disappear after disc cloning. Only full analogue copying without timing restoration will retain the watermark, but this will lead to an increase of timing jitter on the copy. This causes the phase locked loop to produce a larger than expected error signal. Since the amplitude of the error signal is the parameter used to determine whether the disc is an original the disc will be rejected as a duplicate.

FIG. 5 shows a record carrier with asymmetry.

On a Blu Disc-ROM disc 50 the asymmetry of a group of channel bits 52 is modulated by a group of watermark bits. The location of the group of channel bits 52 with asymmetry and a value indicative to- the group of watermark bits are stored at a predefined position, e.g. in the PIC band 51 which is a startup information area of the Blu disc ROM (Read Only Memory) disc.

The storage of the location of the group of channel bits 52, or groups of channel bits, allows a quick access and retrieval of the group of channel bits 52 while providing better security because when the information is not available because of the use of encryption a complete search of the record carrier is required which is time consuming. Further more the asymmetry modulation can be varied for different sections 52, 53 of the disc. The value of the parameter of the asymmetry modulation of the first section 52 is different from the typical value of that parameter on the main part of the disc. The value of the parameter of the asymmetry modulation of the second section 53 of the disc again differs from the value of that parameter in the first section 52. This prevents the determination for illegal copying of the parameter in just one area of the disc and then applying it to some or all other parts of the disc. It is further more possible to select a first parameter for the first section and a second, different, parameter for the second section. Merely detecting a DC content disturbance and subsequently retrieving the parameter is in that case no longer possible because it not known which parameter of several is the essential parameter to obtain a duplicate disc that is recognized as being original. The information about what parameter is used where on the disc can be stored on the disc in encrypted form or can be stored somewhere else for access over a network. If the disturbance are numerous on the disc the authentication of the disc can use different section or combinations of sections each time an authentication is performed, thus preventing the straight forward determination of which sections of the disc are to be accurately duplicated and what parameter is to be considered.

FIG. 6 shows a playback device comprising the asymmetry detector

The playback device 60 retrieves data from the record carrier 61.

As explained in FIG. 5 the information about where the carrier record identification information is located is first retrieved from a special area on the record carrier, for instance the startup information area, which is in the case of blu-disc called the PIC band.

Once the group of channel bits is being retrieved that comprises the asymmetry modulation the block diagram of FIG. 6 becomes valid. The retrieval of the address from the PIC band is within the normal player functionality and need not be discussed. Furthermore the decrypting, if applied, of the keys and addressing information in the PIC band is achieved with the processor device 66.

To retrieve the record carrier identification information from the record carrier the player 60 comprises a basic engine 62 that retrieves channel bits from an address provided to the basic engine 62 by the processor device 66. The retrieved channel bits are then provided to the data slicer 63 and to the DC content determination device 64.

The data slicer 63 effectively removes, as a side effect of the data slicing, the asymmetry from the channel bits before providing the channel bits to the data path for further decoding. In addition a further DC content determining device 67 determines the DC content of the channel bits after the data slicer 63. This further DC content determining device 67 is not required if the DC content of the channel bits is known before hand because of the type constraints placed on the channel bits for instance by the coding. The processor then demodulates based on the first output 68 of the DC content determining device 64 whether at the expected location the expected data was modulated using the asymmetry of the channel bits as detected in the DC content of the retrieved channel bits.

To determine whether the disc is a duplicated disc or an original disc the DC content determining device 64 provides via a second output 68 the value of the parameter of the asymmetry modulation to the processor 66. The processor 66 can then compare the measured value of the parameter to the predetermined value as retrieved from the disc or over a network and determine that, if the value of the parameter differs from the predetermined value, the disc is a duplicate disc, or that, if the value of the parameter is close enough to the predetermined value, the disc is an authentic, i.e. an original disc.

Access to a network can be obtained via the interface 60a of the playback device.

The processor can subsequently either block or allow the further decoding of the channel bits in the data path 65 or alternatively indicate to an external device that the material is copyrighted and may not be recorded by the other device.

Once the record carrier is identified known copy right control systems can be used.

Because the data slicer 63 removes the record carrier identification information before providing the channel bits to the processing by the data path 65 the user has no access to the record carrier identification information. The data slicer 63, DC content determining device 64 and 67 and processor 66 can be integrated into a single device, preventing access by the user. The decryption of the keys, the location of the group of channel bits and the actual content of the group of channel bits are thus well protected from unauthorized access.

The watermark appears among other things in the low-frequency region of the data spectrum and can be recovered by observing the detection level, or by simple low pass- or band pass-filtering the playback signal. Because of the guaranteed 17PP DC-suppression this invention is especially suitable for BD. The watermark detection SNR can be further enhanced by applying a method for minimizing the DC content of the channel bits by coding, in order to limit the low-frequency code spectrum. The latter method is also useful for reducing the amplitude of the asymmetry modulation.

By changing the location and the contents of the watermark from disc to disc, the security of the method is enhanced.

In the signal processing of the Blu Disc drive, keys and the watermark from the CA and PP signal are detected.

The output of the integrator (the detection threshold) will follow the average value asymmetry of the HF-signal. This is a well-known principle and already applied in CD players. It works because of the DC-suppressing property of the channel code.

In this embodiment it is assumed that the bandwidth of the watermark is within the bandwidth of the threshold control loop. Therefore the watermark will not increase the jitter, because the slicer adapts its threshold in order to compensate for the asymmetry modulation.

Above the control bandwidth of the slicer the asymmetry modulation is still present at the output of the threshold detector and the jitter increases.

Prior to playback, the player checks the contents of the watermark at a specific position. The contents and the position of the watermark is encoded into a specific location on the disc, e.g. in the PIC-band (Blu Disc standard).

FIG. 7 shows a copy right control system using asymmetry as a watermark.

The recorder 70 comprises a data path 75 that as part of its function encodes the data into channel bits. The data path then provides the channel bits to the modulator 73.

As described in FIGS. 1, 2 and 3 the modulation can take several forms:
shifting of the transitions of the channel bits
assigning wider pits to certain marks to be recorded to lower reflection
using replacement code words after encoding by replacing code words with code words that do normally not occur in any data stream to control DC content.

Thus the modulator 73 can consequently be implemented as a transition modulator, a code word replacer, or a laser beam power modulator.

The processor 76 receives information from the data path 75 and controls the insertion of the asymmetry modulation in the channel bits. The processor also controls the parameter of the asymmetry modulation or provides the desired value of the parameter to the basic engine 72 to use during the recording. The processor 76 further controls where the channel bits are stored and directs the basic engine 72 to do so.

The channel bits thus processed are provided to the basic engine for recording on the record carrier 61.

It is obvious that the basic engine, in the case of the modulator 73 being a laser beam modulator, must be capable of varying the laser power of the beam it uses to record the channel bits. In the case of the other two modulator embodiments a regular basic engine that allows precise control of the transitions from land to mark and vice versa suffices.

The recorder further also records the location of the channel bits with asymmetry modulation in a special area of the record carrier, such as the PIC band.

The normal configuration of the recorder is suitable for this part of the recording and need not be discussed. The same applies to the encryption of the keys because that is handled by the processor 76 in the regular fashion.

The recording device according to the invention is not limited to professional laser beam recorders, but can also be applied in record-able disc drives like CD-RW, DVD-RW, BD-RE for security reasons.

1. Record carrier comprising a group of channel bits recorded in a track, wherein record carrier identification information is stored in the group of channel bits with an asymmetry modulation where a parameter of the asymmetry modulation has a predetermined value and wherein said asymmetry is obtained through a choice of code words during said coding.

2. Record carrier as claimed in claim 1 where a channel bit of the group of channel bits with an asymmetry modulation has a first transition corresponding to a first predetermined position and a second transition corresponding to a second predetermined position, where at least one transition deviates from a predetermined position by a predetermined amount.

3. Record carrier as claimed in claim 1, wherein the amount is different in a first section of the record carrier compared to a second section of the record carrier.

4. Record carrier as claimed in claim 1, wherein the record carrier is a read only record carrier.

5. Record carrier as claimed in claim 3, wherein the location of the first section is stored in a predetermined position

6. Record carrier as claimed in claim 3, wherein the record carrier comprises a startup information area and that a location of the first section is stored in a Startup information area.

7. Method for recording a record identification information on a record carrier comprising a group of channel bits recorded in a track where the group of channel bits comprises record carrier identification information, comprising the step of:
modulating the record carrier identification information in the group of channel bits with an asymmetry modulation;
storing the group of channel bits with an asymmetry modulation on the record carrier where a parameter of the asymmetry modulation has a predetermined value,
wherein said asymmetry modulation is obtained through a choice of code words during coding.

8. Method for recording a record carrier identification information as claimed in claim 7, wherein the method comprises the step of storing the predetermined value of the parameter of the asymmetry modulation in a data field on the record carrier.

9. Method for recording a record carrier identification information as claimed in claim 8, wherein the predetermined value of the parameter of the asymmetry modulation is encrypted.

10. Method for recording a record carrier identification information as claimed in claim 7, wherein the step of modulating the record carrier identification information in the group of channel bits with an asymmetry modulation comprises the step of modulating the record carrier identification information in the group of channel bits that are to be stored in a first section of the record carrier with an asymmetry modulation with a parameter having a first value and the step of modulating the record carrier identification information in the group of channel bits that are to be stored in a second section of the record carrier with an asymmetry modulation with a parameter having a second value.

11. Method for recording a record carrier identification information as claimed in claim 7, wherein the record carrier comprises a startup information area and that a location of the data field is stored in the startup information area.

12. Method for retrieving a record identification information from a record carrier comprising a group of channel bits recorded in a track where the group of channel bits comprises record carrier identification information, comprising the step of:
retrieving a group of channel bits with an asymmetry modulation from the record carrier, wherein said asymmetry modulation was obtained through a choice of code words;
demodulating the record carrier identification information from the retrieved group of channel bits with an asymmetry modulation;
retrieving a value of a parameter of the asymmetry modulation
comparing the retrieved value of the parameter to a predetermined value
providing the record carrier identification information if the retrieved parameter is within a predefined range of the predetermined value.

13. Method for retrieving a record carrier identification information as claimed in claim 12, wherein the step of comparing the value of the parameter to a predetermined value comprises the step of retrieving the predetermined value from a data field on the record carrier.

14. Method for retrieving a record carrier identification information as claimed in claim 12, wherein the step of comparing the value of the parameter to a predetermined value comprises the step of retrieving the predetermined value from a location via a network.

15. Method for retrieving a record carrier identification information as claimed in claim 12, wherein the step of demodulating the record carrier identification information in the group of channel bits with an asymmetry modulation comprises the step of retrieving a parameter having a first value from a first group of channel bits with an asymmetry modulation that are stored in a first section of the record carrier and retrieving a parameter having a second value from a second group of channel bits with the asymmetry modulation that are stored in a second section of the record carrier

16. Method for retrieving a record carrier identification information as claimed in claim 12, wherein the record carrier comprises a startup information area and that the pointer of the predetermined position is retrieved from the startup information area.

17. Method for copy right control of information stored on a record carrier where the record carrier comprises a record carrier comprising a group of channel bits recorded in a track of the record carrier where the group of channel bits comprises record carrier identification information, comprising the step of:
retrieving a group of channel bits with an asymmetry modulation from the record carrier, wherein said asymmetry modulation was obtained through a choice of code words;
retrieving a value of a parameter of the asymmetry modulation from the retrieved group of channel bits;
comparing the value of the parameter with a predetermined value; if the value of the parameter is within a predetermined range of the predetermined parameter:
complete processing the retrieved group of channel bits to establish a copy right status of the record carrier; if the value of the parameter is outside a predetermined range of the predetermined parameter:
declare a copy right status of the record carrier to be a violation of a copy right.

18. Method for copy right control of information stored on a record carrier as claimed in claim 17, wherein the step of comparing the value of the parameter with a predetermined value comprises the step of retrieving the predetermined value of the parameter of the asymmetry modulation from a data field on the record carrier

19. Method for copy right control of information stored on a record carrier as claimed in claim 17, wherein the characterized in that the step of comparing the value of the parameter to a predetermined value comprises the step of retrieving the predetermined value from a location via a network.

20. Method for copy right control of information stored on a record carrier as claimed in claim 17, wherein the record carrier comprises a startup information area and that a location of the data field is retrieved from the startup information area.

21. Playback device for optical discs comprising an addressing means and a data retrieval means, wherein the playback device further comprises a DC content retrieval means that is arranged for retrieving a record carrier identification information from a record carrier comprising a demodulator for demodulating an asymmetry of a group of channel bits retrieved from the record carrier from an address indicated by the addressing means and that a parameter retrieval means is coupled to the DC content retrieval means for retrieving a value of a parameter of the asymmetry of the group of channel bits, wherein said asymmetry modulation was obtained through a choice of code words.

22. Playback device as claimed in claim 21, wherein the playback device further comprises a copy right control means of which an input is coupled to an output of the parameter retrieval means for receiving a value of the parameter and where the copy right control means is arranged for determining a copy right status based on the value of the parameter received from the parameter retrieval means.

23. Recording device for record carriers comprising an addressing means and a data recording means, wherein the recording device further comprises a asymmetry modulation device that is arranged for storing a record carrier identification information on a record carrier by modulating an asymmetry of a group of channel bits, wherein said asymmetry modulation was obtained through a choice of code words, where the asymmetry has a predetermined value, where the asymmetry modulation device is coupled to the data recording means which is arranged for recording the group of channel bits provided by the asymmetry modulation device on an location on the record carrier indicated by the addressing means.
